(19) United States
(12) Patent Application Publication
(10) Pub. No.: US 2019/0345881 A1
(43) Pub. Date: Nov. 14, 2019

(54) DUAL FUEL INJECTOR

(71) Applicant: DELPHI TECHNOLOGIES IP LIMITED, St. Michael (BB)

(72) Inventors: Joseph Stanbridge, Bristol (GB); George A. Meek, Aylburton, Gloucestershire (GB)

(21) Appl. No.: 16/335,543

(22) PCT Filed: Sep. 15, 2017
(86) PCT No.: PCT/EP2017/073335

§ 371 Date: Mar. 21, 2019

(30) Foreign Application Priority Data
Sep. 21, 2016 (GB) 1616066.5

(51) Int. Cl. F02D 19/06; F02D 19/10; F02D 41/00; F02M 43/04; F02M 61/18

(52) U.S. Cl. CPC F02D 19/0647; F02D 19/0678; F02M 61/1853; F02D 41/0027; F02M 43/04; F02D 19/10

(57) ABSTRACT

A dual-fuel injector to be arranged in a dual-fuel injection equipment of an internal combustion engine extends along a main axis from a top-head to a nozzle-tip. A first circuit conveys a first fuel to a first set of injection holes and a second circuit conveys a second fuel to a second set of injection holes.

### CROSS REFERENCE TO RELATED APPLICATIONS

This application is a national stage application under 35 USC 371 of PCT Application No. PCT/EP2017/073335 having an international filing date of Sep. 15, 2017, which is designated in the United States and which claimed the benefit of GB Patent Application No. 1616066.5 filed on Sep. 21, 2016, the entire disclosures of each are hereby incorporated by reference in their entirety.

### TECHNICAL FIELD

The present invention relates to dual-fuel equipment and more particularly to dual-fuel injector and the structure of said injector enabling to inject diesel fuel and compressed natural gas within the same injector.

### BACKGROUND OF THE INVENTION

Internal combustion engines operating on two different fuels are generally provided with two distinct fuel equipment comprising two injectors each injecting one fuel in the same piston.

Creating a single injector adapted to inject two fuels raises major problems for instance of internal leaks risking to mixing said fuels. Actually, truck engines that are historically diesel engines are developing to run on diesel fuel and compressed natural gas (GNG). The pressure of both diesel and CNG ranges up to 500 bars and it is intended to raise this level.

In said truck engines, the main injection event during the combustion cycle is performed with CNG which requires large quantities, this event generates pressure waves that internally propagate with very little damping.

Also, on known CNG injectors operating in a smaller range of pressure, the CNG enters the injector via an inlet where sealing is provided by O-rings arranged between male and female pipes. This specific behaviour of CNG associated to the raising pressure creates leaks through said O-ring classical connections.

### SUMMARY OF THE INVENTION

Accordingly, it is an object of the present invention to resolve the above mentioned problems in providing a dual-fuel injector adapted to be arranged in a dual-fuel injection equipment of an internal combustion engine. Said dual-fuel injector generally extends along a main axis, from a top-head to a nozzle-tip and it internally accommodates a first circuit for conveying a first fuel from a first inlet to a first set of injection holes provided in the nozzle tip and, a second circuit for conveying a second fuel from a second inlet to a second set of injection holes provided in the nozzle tip. The dual-fuel injector further comprises
a first control-valve arranged to control the pressure of the first fuel in a first control chamber thus forcing the opening, or closing, of a first valve member enabling, or forbidding, injection of the first fuel via the first set of injection holes and,
a second control-valve arranged to control the pressure of the first fuel in a second control chamber thus forcing the opening, or closing, of a second valve member enabling, or forbidding, injection of the second fuel via the second set of injection holes.

The dual-fuel injector further comprises a first inlet body arranged in the head of the injector and axially extending from an upper face to a transverse under face, and being provided with the first inlet, the under face of the first inlet body being in surface contact against the second control valve.

The dual-fuel injector further comprises a second inlet body axially extending from a transverse upper face to an opposed transverse under face, the first control valve being arranged in a recess provided in said upper face of the second inlet body.

Also, the dual-fuel injector further comprises a first capnut bearing on a shoulder face of the first inlet body and being firmly tightened on the second inlet body, thus fixing in axial co-alignment the two control valve compressed between the two inlet bodies.

Also, the dual-fuel injector is further provided with a barrel member and a nozzle assembly, the upper face of the barrel member being in surface contact against the under face of the second inlet body and, the under face of said barrel member being in surface contact against the upper face of the nozzle assembly and wherein, the second control chamber is defined in said barrel member.

Also, the first and second valve members, are axially guided in the nozzle assembly and, the first control chamber is defined in said nozzle assembly.

Also, the dual-fuel injector further comprises a second capnut bearing on a shoulder face of the nozzle assembly and being firmly tightened on the second inlet body thus Fixing in axial co-alignment the barrel member compressed between the nozzle assembly and the second inlet body.

The first circuit provided for conveying the first fuel comprises
a first high pressure line extending from the first inlet to the first set of holes,
a first branch extending from said first high pressure line to the first control chamber and,
a second branch extending from said first high pressure line to the second control chamber and wherein,

said first circuit further comprises
a first return line extending from the first control chamber toward an outlet, said first return line being controlled by the first control-valve and,
a second return line extending from the second control chamber toward the outlet, said second return line being controlled by the second control-valve.

The second circuit solely comprises a second high pressure line for conveying the second fuel from the second inlet to the second set of holes.

The first fuel is a diesel fuel and the second fuel is compressed natural gas (CNG).

The second high pressure line comprises several parallel channels merging in a common gallery arranged in the vicinity to the nozzle tip, said second high pressure line having an overall volume comprised between 10 cm³ and 18 cm³.

The first inlet opens in a metallic part and it defines a first female face adapted to receive a complementary male face of a high pressure pipe forming a first metal-to-metal seal when tightened against each other.

The second inlet opens in a metallic part and it defines a female face adapted to receive a complementary male face of a high pressure pipe forming a second metal-to-metal seal when tightened against each other.

The invention further extends to a dual-fuel injection equipment comprising at least one dual-fuel injector as previously mentioned.

### BRIEF DESCRIPTION OF THE DRAWINGS

The present invention is now described by way of example with reference to the accompanying drawings in which:

FIG. 1 is a 3D view of an internal combustion engine operating on two different fuels conveyed by an injection equipment provided with dual-fuel injectors as per the invention.

FIG. 2 is a 3D representation of the dual-fuel injector represented on FIG. 1.

FIG. 3 is an axial section of the dual-fuel injector represented on FIG. 1 and FIG. 2.

FIG. 4 is a transparent representation of the dual-fuel injector of FIGS. 2 and 3, said view enabling to visualize a fuel line for a second fuel.

### DESCRIPTION OF THE PREFERRED EMBODIMENTS

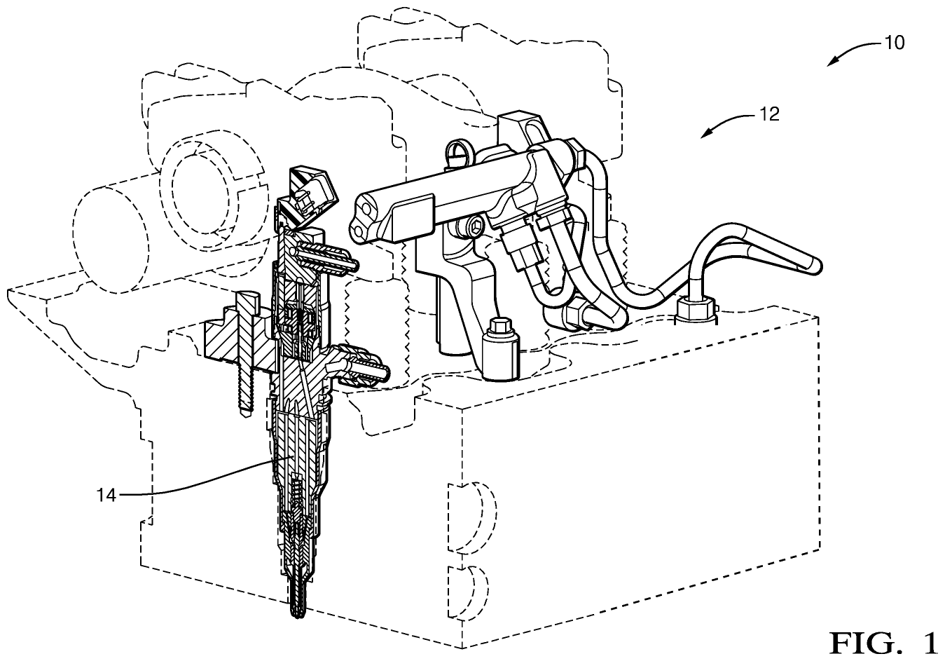

In reference to FIG. 1 is described a dual-fuel internal combustion engine 10 sketched in phantom lines and provided with a dual-fuel injection equipment 12 adapted to inject diesel fuel, hereafter diesel or first fuel F1, and compressed natural gas, hereafter CNG or second fuel F2 that are both pressurised to about 500 bars.

The dual-fuel injection equipment 12 comprises a pump, several pipes and a dual-fuel common-rail, or manifold, the diesel first fuel F1 and the CNG second fuel F2 being segregated from each other, both fuels being delivered to the same dual-fuel injectors 14 provided with separate first inlet 16 for the first fuel F1 and, second inlet 18 for the second fuel F2, said fuels being alternatively sprayed, via separate sets of spray holes, in the piston. On FIG. 1 only one injector 14 is represented in axial section although it is known that several injectors equip a multi-piston engine such as a truck engine.

Also, the injector 14 comprises different members stacked on the top of each other and, said lengthy arrangement enables to arrange the injector 14 in a deep well provided in the engine block still having the first 16 and second 18 inlets outside the well, this facilitating the connections of pipes of the fuel equipment.

An injection event is a sequence of individual events happening around the top dead centre (TDC) position of a piston, said sequence comprising one or several pilot-injection, or pre-injection, one main injection followed by one or several post-injection events. During the pre- and the post-injections a small quantity of first fuel F1 is sprayed in the piston of the engine and, during the main injection a large quantity of second fuel F2 is sprayed in said piston.

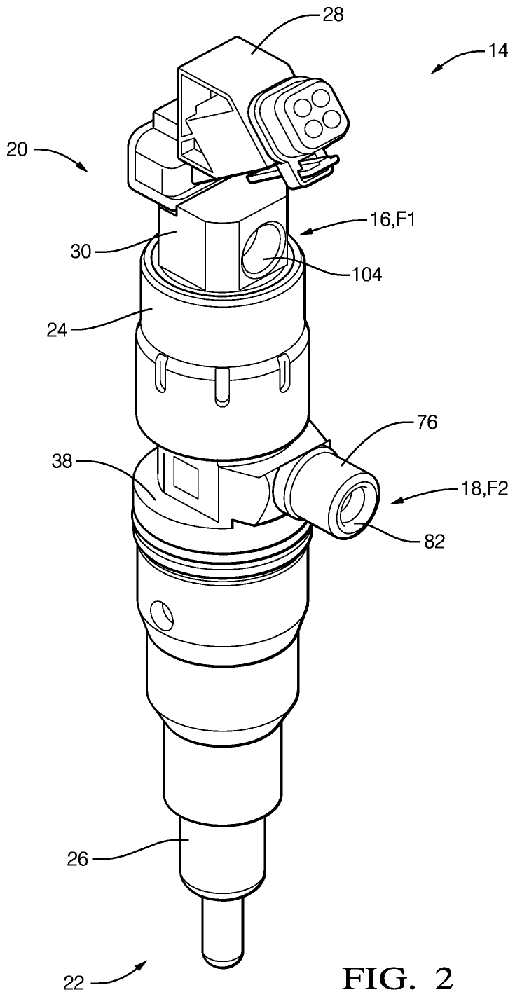

More in details in reference to the FIGS. 2 to 4, the dual-fuel injector 14 has an elongated shape extending along a main axis X from a head 20 to a nozzle tip 22 and, in-between, the injector 14 comprises several members stacked on the top of each other and firmly maintained together by a first capnut 24 and a second capnut 26.

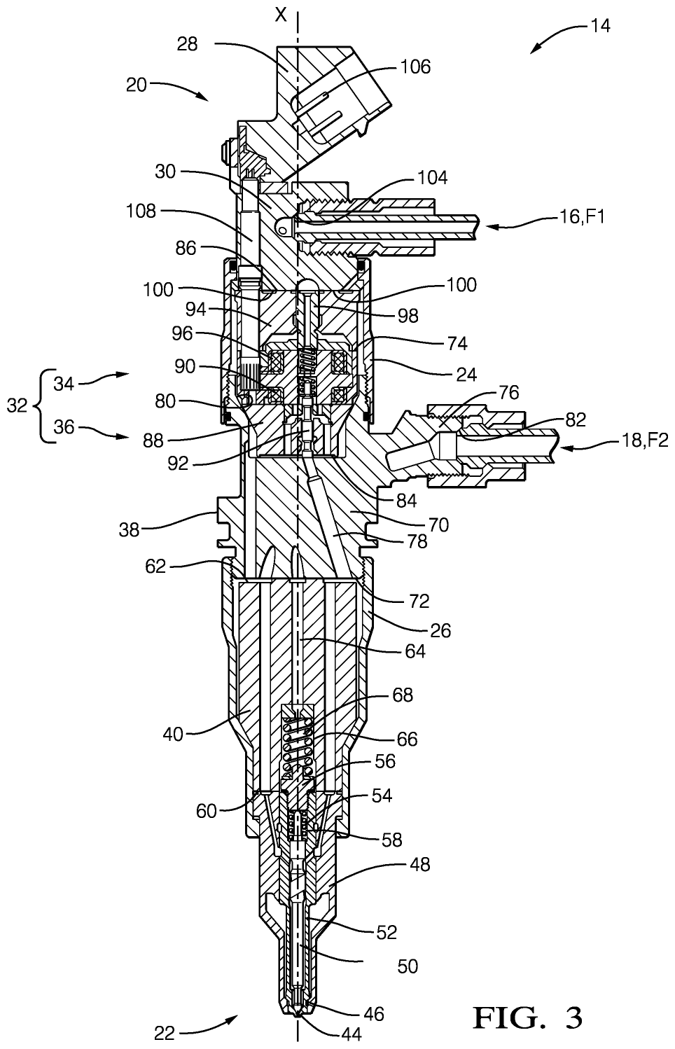

From top to bottom, following the arbitrary orientation of FIG. 3, the injector 14 comprises an electrical connector 28 arranged on the top of a first inlet body 30, wherein is defined the first inlet 16, then a double control valve assembly 32 comprising a second control valve 34 and below it, a first control valve 36 arranged against a second inlet body 38, wherein is defined the second inlet 18, then follows a barrel member 40 and a nozzle assembly 42 at the tip of which are arranged the injection holes.

A part of the connector 28 that is usually moulded in plastic material, the other members of the injector 14 are all metallic.

The first capnut 24 bears on a shoulder face provided on the outer face of the first inlet body 30 and, it is screwed to the second inlet body 38, the double control valve assembly 32 being compressed in-between. The second capnut 26 bears on a shoulder face of the outer face of the nozzle assembly 42 and, it is also firmly screwed on the second inlet body 38 that is provided on its outer face with two male threads, the barrel member 40 being compressed between said body 38 and nozzle 42.

The injector 14 further accommodates a first circuit C1 for conveying the first fuel F1 from the first inlet 16 to the nozzle tip 22 where said first fuel F1 is sprayed via a first set of holes 44 and also, a second circuit C2 for conveying the second fuel F2 from the second inlet 18 to the nozzle tip 22 where said second fuel F2 is sprayed via a second set of holes 46.

Precisely, the nozzle assembly 42 comprises a nozzle body 48 extending from an upper transverse face to the tip where are sprayed the fuels, said body 48 having a peripheral wall surrounding an inner space in which a double valve member is axially guided. Said double valve member comprises of a first valve member 50 concentrically guided in a bore provided inside a second valve member 52. The second valve member 52 is a hollow needle adapted to open or close the second set of holes 46 arranged through the bottom end of the peripheral wall of the body 48 and, the first valve member 50 is a plain needle, or inner needle, adapted to open or close the first set of holes 44 arranged through the bottom of said hollow needle 52.

A plug 56 arranged at the end of the hollow needle 52 distant from the injection holes seals the bore enclosing the inner needle 50 and defining a first control chamber 58 between the top end of the inner needle 50 and said sealing plug 56. A first spring 54, compressed in said first control chamber 58 between the plug 56 and the inner needle 50, biases said needle 50 is in a closed position of the first holes 44.

In the nozzle assembly 42, the first fuel circuit C1 divides forming a first fuel injection path extending in the bore of the hollow needle 52 around the inner needle 50 leading to the first set of holes 44 and, a first control path leading to the first control chamber 58, the inner needle 50 lifting to open the first holes 44 when the pressure of the first fuel F1 in said first control chamber 58 drops below a first threshold.

The barrel member 40, arranged above the nozzle assembly 42, extends from an under face 60 pressed in surface contact against the upper transverse face of the nozzle body to, an upper transverse face 62 and, said barrel member 40 is provided with portions of the first fuel circuit C1, portions of the second fuel circuit C2, and also with a conduit forming a second control path 64 axially X extending from the centre of said upper face 62 to the centre of said under face 60 where said second control path 64 opens in the top face of a cylindrical recess defining a second control chamber 66 arranged right above the second valve member 52, the plug 56 in fact partially protruding in said second control chamber 66.

A second spring 68 compressed inside said second control chamber 66 between said top face and the upper face of the plug 56 biases the second valve member 52 is in a closed position of the second holes 46.

The first fuel F1 flows in said second control path 64 and fills the second control chamber 66 and, when the pressure of the first fuel F1 in said second control chamber drops below a second threshold the hollow needle 52 lifts-up and opens the second set of holes 46.

The second inlet body 38, arranged above the barrel member 40, has a main cylindrical member 70 from which extends an integral radial extension 76 wherein is defined the second inlet 18. The main member 70 axially extends from a transverse under face 72 pressed in surface contact against the upper face 62 of the barrel member to an upper transverse face 74.

The second inlet body 38 accommodates other portions of the first circuit C1 downwardly conveying the first fuel F1 toward the nozzle assembly 42 and also, a section of a first return channel 78 enabling the first fuel F1 enclosed in the first control chamber 58 to exit and return toward a first fuel outlet, not represented.

Also, portions of the second fuel circuit C2 are provided in the second inlet body 38 wherein they extend toward the second inlet 18 that defines, in said radial extension 76, a cylindrical channel ending in an enlarging female conical face 82. The extension is externally threaded and adapted to receive a complementary nut which, when tightened over the radial extension 76 forces the end face of a pipe, in which is conveyed the CNG, in metal-to-metal sealing contact against said female conical face 82 of the second inlet.

This metal-to-metal sealing arrangement has proven to be an efficient sealing arrangement new to CNG use, and more generally to any compressed gas. Said arrangement can be implemented to gas, or CNG, injectors provided with a single inlet.

In its upper end, the main member 70 of the second inlet body is provided with a recess 80 opening in the upper face 74, thus limiting said upper face 74 to an annular edge surrounding said recess 80. In said recess is arranged the first control valve 36 and, right above the second control valve 34.

The double control valve assembly 32 comprising the first 36 and the second 34 control valves extends from an under face 84 of the first control valve to an upper face 86 of the second control valve. The first control valve 36 has a first body 88 defining said under face 84 of the assembly, body 88 in which is fixed a first solenoid 90 that cooperates with a first armature-and-spool assembly 92 axially guided in a hydraulic bore and armature chamber provided in said first body 88. The second control valve 34 arranged atop the first control valve 36 has a second body 94 defining said upper face 86 of the assembly, body 94 in which is fixed a second solenoid 96 that cooperates with a second armature-and-spool assembly 98 axially guided in another hydraulic bore and armature chamber arranged in said second body 94. As it is visible on the figure, the two control valve are arranged so the armature-and-spool assemblies are aligned and adapted to slide in opposite directions.

The first inlet body 30 is a cylindrical member having an under face 100 pressed in surface contact against the upper face 86 of the second control valve and an upper face 102 that is an external face of the injector 14. The first fuel circuit C1 extends in said first inlet body 30 where it joins the first inlet 16 that extends radially in said body 30. The first inlet 16 is defined by another female conical face 104 that enlarges the extremity of the first fuel channel C1, said female conical face 104 joining a larger cylindrical threaded bore adapted to receive a complementary nut which forces the end face of a pipe, in which is conveyed the pressurised diesel F1, in metal-to-metal sealing contact against said female conical face 104 of the first inlet 16.

The electrical connector 28, shaped to receive a complementary connector of a command unit not represented, is fixed atop the first inlet body 30 and it comprises electrical pins 106 from which extends electrical leads 108 arranged in a specific bore provided in the first inlet body and in the two control valves bodies, the end of said leads 108 being connected to the first 90 and the second 96 solenoids.

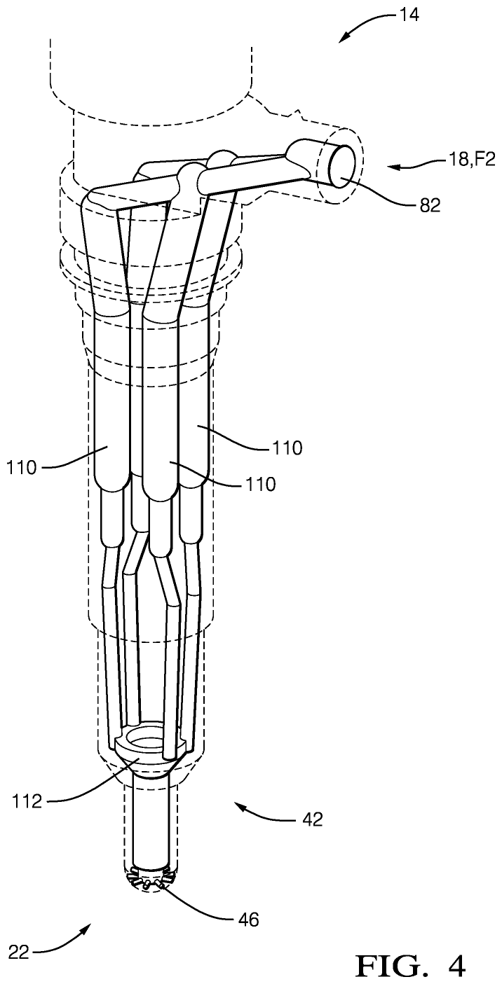

More in detail in reference to FIG. 4, the second fuel circuit C2 conveying, in use, CNG from the second inlet 18 to the second sets of holes 46, extends from the second inlet 18 in a single short portion that rapidly divides to form four channel 110 which, after a short radial portion arranged in the second inlet body 38 reorient and downwardly extend through the second inlet body and the barrel member prior to enter the nozzle body 48, wherein said four parallel channels 110 merge in a large gallery 112 formed within the inner space of the nozzle body. Alternatively, four channels are represented while in another embodiment, said channels 110 could be three, five, or any other number depending on the available space wherein it is possible to arrange them. Also, the large internal accumulator volume is not just restricted to the design with cylindrical channels 110. In an alternative not represented, channels 110 could also be replaced with a single continuous column contained within the injector such as within capnut 20 surrounding other members.

Moreover, as it is visible said four channels 110 occupy as much space as possible, the upper portions of the channels 110 in the second inlet body 38 and in the barrel member 40 having a large cross-section. In the injector 14 presented, which is designed for a truck engine, it has been possible to arrange an overall volume of 13 cm³ for the second fuel circuit C2. In other embodiments of injectors, a second fuel circuit C2 having a volume capacity between 12 and 18 cm³ is possible. This large inner space within the nozzle body enables that an important volume of CNG to be ready to inject, accumulated very close to the injection holes 46.

The operation of the injector 14 is now partially summarised.

Initially, none of the solenoid 90, 96 is energised, the armature-and-spool assemblies 92, 98 a biased away from their respective solenoid closing return channels and preventing first fuel F1 to exit the first 58 and the second 66 control chambers. Consequently, the first fuel pressure rises in both control chambers exerting forces onto both valve members 50, 52 that close both sets of holes 44, 46 forbidding any fuel injection.

In the subsequent pilot steps, the command unit energises only the first solenoid 90 generating a magnetic field that attracts the first armature-and-spool assembly 92 which displaces and opens the first return channel enabling the first fuel F1 to exit the first control chamber 58. The pressure in said first control chamber drops allowing the needle 50 to lift and open the first set of holes 44, therefore injecting diesel F1 into the piston. This pilot step is short since the quantity injected is small during the pilot injection. This sequence of events is similar in the case of a post-injection events.

In the subsequent main injection step, the first solenoid 90 is no longer energised thus the first sets of holes 44 are closed and no diesel is injected and, the second solenoid 96 is energised attracting the second armature-and-spool assembly 98 and releasing the first fuel F1 confined in the second control chamber 66. The pressure in said second control chamber 66 drops enabling the second valve member 52 to lift-up and open the second set of holes 46 through which the CNG F2 is sprayed into the piston. This main injection step is quite long since a significant quantity of CNG is injected from the gallery 112. Also, during these steps, the hollow needle opens and closes and, the inertia within the system means that pressure waves are generated and propagate inside the second fuel F2. Said pressure waves are damped within the second circuit C2 due to the large volumes contained in channels 110.

### LIST OF REFERENCES

X main axis
F1 first fuel—diesel
F2 second fuel—CNG
C1 first circuit
C2 second circuit
10 engine
12 dual-fuel injection equipment
14 dual-fuel injector
16 first inlet
18 second inlet
20 head of the injector
22 nozzle tip
24 first capnut
26 second capnut
28 connector
30 first inlet body
32 double control valve assembly
34 second control valve
36 first control valve
38 second inlet body
40 barrel member
42 nozzle assembly
44 first set of holes
46 second set of holes
48 nozzle body
50 first valve member—needle
52 second valve member—hollow needle
54 first spring
56 plug
58 first control chamber
60 under face of the barrel member
62 upper face of the barrel member
64 second control path
66 second control chamber
68 second spring
70 main member of the second inlet body
72 under face of the second inlet body
74 upper face of the second inlet body
76 radial extension
78 first return channel
80 recess
82 female conical face of the second inlet
84 under face of the first control valve
86 upper face of the second control valve
88 first body of the first control valve
90 first solenoid
92 first armature-and-spool assembly
94 second body of the first control valve
96 second solenoid
98 second armature-and-spool assembly
100 under face of the first inlet body
102 upper face of the first inlet body
104 female conical face of the first inlet
106 electrical pins
108 electrical leads
110 parallel channels of the second fuel circuit
112 gallery

1-10. (canceled)

11. A dual-fuel injector adapted to be arranged in a dual-fuel injection equipment of an internal combustion engine, said dual-fuel injector extending along a main axis, from a top-head to a nozzle-tip, and internally accommodating a first circuit for conveying a first fuel) from a first inlet to a first set of injection holes provided in the nozzle tip and, a second circuit for conveying a second fuel from a second inlet to a second set of injection holes provided in the nozzle tip, the dual-fuel injector comprising:
a first control-valve which controls pressure of the first fuel in a first control chamber thus opening or closing a first valve member, thereby enabling or forbidding injection of the first fuel via the first set of injection holes;
a second control-valve arranged to control pressure of the first fuel in a second control chamber thus opening closing a second valve member enabling or forbidding injection of the second fuel via the second set of injection holes;
a first inlet body arranged in the top-head of the dual-fuel injector and axially extending from an upper face to a transverse under face, and being provided with the first inlet, the transverse under face of the first inlet body being in surface contact against the second control-valve;
a second inlet body axially extending from a transverse upper face to an opposed transverse under face, the first control valve being arranged in a recess provided in said transverse upper face of the second inlet body;
a first capnut bearing on a shoulder face of the first inlet body and being tightened on the second inlet body, thus fixing in axial co-alignment the first control-valve and the second control valve compressed between the first inlet body and the second inlet body; and
a barrel member and a nozzle assembly, an upper face of the barrel member being in surface contact against the opposed transverse under face of the second inlet body and, an under face of said barrel member being in surface contact against an upper face of the nozzle assembly, wherein the second control chamber is defined in said barrel member.

12. A dual-fuel injector as claimed in claim 11, wherein the first valve member and the second valve member are axially guided in the nozzle assembly and, the first control chamber is defined in said nozzle assembly.

13. A dual-fuel injector as claimed in claim 11 further comprising a second capnut bearing on a shoulder face of the nozzle assembly and being tightened on the second inlet body, thus fixing in axial co-alignment the barrel member compressed between the nozzle assembly and the second inlet body.

14. A dual-fuel injector as claimed in claim 11, wherein the first circuit provided for conveying the first fuel comprises:
a first high pressure line extending from the first inlet to the first set of injection holes;
a first branch extending from said first high pressure line to the first control chamber;
a second branch extending from said first high pressure line to the second control chamber;
a first return line extending from the first control chamber toward an outlet, said first return line being controlled by the first control-valve; and
a second return line extending from the second control chamber toward the outlet, said second return line being controlled by the second control-valve.

15. A dual-fuel injector as claimed in claim 14, wherein the second circuit solely comprises a second high pressure line for conveying the second fuel from the second inlet to the second set of injection holes.

16. A dual-fuel injector as claimed in claim 15, wherein the first fuel is diesel fuel and the second fuel is compressed natural gas.

17. A dual-fuel injector as claimed in claim 15, wherein the second high pressure line comprises a single volume or several parallel channels merging in a common gallery arranged in the vicinity to the nozzle tip, said second high pressure line having an overall volume comprised between 10 cm³ and 18 cm³.

18. A dual-fuel injector as claimed in claim 15, wherein the first inlet opens in a metallic part and defines a first female face adapted to receive a complementary male face of a first high pressure pipe forming a first metal-to-metal seal when tightened against each other.

19. A dual-fuel injector as claimed in claim 18, wherein the second inlet opens in a metallic part and defines a second female face adapted to receive a complementary male face of a second high pressure pipe forming a second metal-to-metal seal when tightened against each other.

20. A dual-fuel injector as claimed in claim 11, wherein the first fuel is diesel fuel and the second fuel is compressed natural gas (CNG).

21. A dual-fuel injection equipment comprising at least one dual-fuel injector as claimed in claim 11.
